(19) United States
(12) Patent Application Publication
(10) Pub. No.: US 2010/0082713 A1
(43) Pub. Date: Apr. 1, 2010

(54) METHOD AND SYSTEM FOR ATTACHING FILES TO E-MAIL FROM BACKUP COPIES REMOTELY STORED

(75) Inventors: MARTIN FRID-NIELSEN, Menlo Park, CA (US); Song Zun Huang, Scotts Valley, CA (US); Steven Ray Boye, Vaerloese (DK)

Correspondence Address: HAYNES BEFFEL & WOLFELD LLP, P O BOX 366, HALF MOON BAY, CA, 94019, US

(73) Assignee: SOONR, Menlo Park, CA (US)

(21) Appl. No.: 12/242,149

(22) Filed: Sep. 30, 2008

(51) Int. Cl. G06F 17/30; G06F 15/16; G06F 7/00

(52) U.S. Cl. 707/821; 709/206; 707/E17.032; 707/E17.01

(57) ABSTRACT

The technology disclosed relates efficient handling of e-mail attachments. In particular, it relates to automatic and efficient matching of a selected local file to an archived file for attachment of the archived file or a link thereto to an e-mail, without requiring uploading of the local file when initiating the e-mail.

### RELATED APPLICATIONS

This application is related to U.S. patent application Ser. No. 11/239,669, entitled “VIRTUAL PUBLICATION OF DATA, ADAPTED FOR MOBILE DEVICES” filed 29 Sep. 2005 and claiming the benefit of U.S. Provisional Application No. 60/715,415, entitled “PRIVATE MOBILE NETWORKS” filed 9 Sep. 2005. The related application and provisional application are hereby incorporated by reference.

Two contemporaneous companion cases also were filed on 29 Sep. 2005, which were assigned U.S. patent application Ser. Nos. 11/238,838 and 11/238,839.

### BACKGROUND OF THE TECHNOLOGY DISCLOSED

The present technology disclosed relates efficient handling of e-mail attachments. In particular, it relates to automatic and efficient matching of a selected local file to an archived file for attachment of the archived file or a link thereto to an e-mail, without requiring uploading of the local file when initiating the e-mail.

Today, most people “share” files with each other as attachments to emails. In fact, responding to an email saying “Hey, can you send me the latest business overview”, is probably one of the most common catalysts to sending a file to someone. We use MICROSOFT OFFICE OUTLOOK® as an example email program for illustrative purposes, because it has a large market share in the business markets.

When one receives a request from someone to send them a presentation, several steps are required to share the presentation.

1. Create or reply to an email.

2. Click on the attach file button.

3. Choose the file from the File Explorer.

4. Click Send.

This 4-step process is repeated every day. In the background, OFFICE OUTLOOK® sends a copy of this email with its attachment to the server and it is passed on to the recipient. Each recipient gets a copy of the attachment and often saves it to their local or network hard drive. This is very inefficient, as there are rampant duplicates within a company.

One company that has improved efficiency by reducing the size of attachments, without addressing the problem of duplicates, is BALESIO™ The product PPT MINIMIZER™ will intercept any OFFICE OUTLOOK® email with a PowerPoint attachment and compress the PowerPoint stack before sending it off to the user. This can happen in the background without user intervention or in a verbose mode under user control. The 4-step process is unchanged. The program engages after the user clicks send. In the background, the following happens.

1. PPT MINIMIZER™ detects that there is a PPT attached to the email. In verbose mode, it prompts the user and asks if they wish to compress the PPT.

2. In this verbose case, the user has to click on the “Yes” option to continue. If you click no, OFFICE OUTLOOK® just sends the PPT file attached to the email like normal.

3. When the user clicks “Yes”, compression proceeds. The programs UI displays progress bars.

4. After the compression, the new file is attached to the OFFICE OUTLOOK® email, optionally with a variation on the original file name, and then sent via normal OFFICE OUTLOOK® methods. Following compression, the new email has a PPT attachment that is 50% smaller.

This process for compressing PowerPoint attachments is local and does not suggest anything more than registering a specialized agent to handle compression of typical files sent by e-mail. It does not address the duplication issue.

Document management software sometimes addresses the duplication issue by allowing internal, licensed users to send links among themselves that are resolved by invoking the licensed document management software. For instance, WORLDOX® has a feature that allows a licensed user to locate a file stored within the document management database and to send another registered user a link to that file. The other licensed user relies on the document management software to resolve the link. Steep license fees and strict head count limits for the document management software typically limit this approach.

Yet another type of software overcomes the size limit on e-mail attachments, by facilitating a user's upload of files to a linking site and forwarding of a link to a selected destination. YOUSENDIT™ is a sample of this online service genre, which encourages recipients to download the linked files before they are automatically erased.

The availability of these three varieties of software evinces a long felt need to improve on use of e-mail for forwarding documents, while demonstrating the limits on current thinking about desirable avenues of improvement.

An opportunity arises to improve on the standard workflow for attaching files to e-mails. Better, more efficient and more responsive e-mail components and systems may result.

### SUMMARY OF THE TECHNOLOGY DISCLOSED

The technology disclosed relates efficient handling of e-mail attachments. In particular, it relates to automatic and efficient matching of a selected local file to an archived file for attachment of the archived file or a link thereto to an e-mail, without requiring uploading of the local file when initiating the e-mail. Particular aspects of the technology disclosed are described in the claims, specification and drawings.

### BRIEF DESCRIPTION OF THE DRAWINGS

FIG. 1 illustrates a private mobility network.

FIG. 2 is a block diagram of a mobility server.

FIG. 3 is a functional block diagram of an attachment server.

FIG. 4 is a functional block diagram of a network agent that resides on network components capable of mounting such software.

FIG. 5 depicts an attachment agent that also runs on the local host of devices that send e-mail.

FIGS. 6-7 are high level flowcharts for handling an attachment event, from the perspectives of the attachment agent and attachment server.

### DETAILED DESCRIPTION

The following detailed description is made with reference to the figures and carries through into the claims.

### Environment

This assignee's prior applications, referenced above, describe automatically backing up and uploading data in a heterogeneous network (having different nodes with different display capabilities needing data) on a private mobile network. Either backing up data or uploading it (collectively “upload”) to the mobility server has the same result, that the data becomes available in the so-called cloud. Links can be provided to data or proxies to data in the cloud without repeatedly uploading the data. The mobility server handles security and makes data available to authorized persons, often traversing corporate boundaries. That network includes a mobility server, mobile components and fixed components. Data is stored on behalf of network members. In one embodiment, backup or mobility agents (collectively “upload agents”) reside on fixed components and selected mobile components. The upload agent detects a change in data on a fixed or mobile network component meeting a backup criteria for the component and initiates copying of the data to a backup or mobility server. Alternatively, regardless of “back up” intent, users designate files to be cached in the cloud. For instance, files from a desktop machine or a network server can be cached to the cloud before the user starts a trip, so that the files will be available if needed during the trip. More details of this automated process are given in the applications that are incorporated by reference. It is recognized that any of the backup or uploading technology described in those applications or otherwise described in this application may be combined with other features of the e-mail attachment technology disclosed herein. Similarly, uploading technology such as Apple's iDisk™ can be combined with features of the e-mail attachment technology described.

### Overview

The technology described below recognizes files that have been uploaded to the backup or mobility server (collectively “mobility server”) when the user selects them from local storage to be used as a message attachment. This technology automatically detects the availability of one or more versions of the file on the mobility server and informs the user of the benefits of the new way of sharing. This new way involves attaching the uploaded file or a link to the uploaded file to the e-mail, without the user waiting for the attachment to upload and/or without creating additional duplicates of the file.

The new technology does not require that the user deviate from the regular e-mail attachment process. Once again, the user follows four 4 steps to “attach” a file to an email.

1. Create or reply to an email.

2. Click on the attach file button.

3. Choose the file from the File Explorer.

4. Click Send.

Then, a software agent running on a computer (“attachment agent”) automatically offers the user a new way of attaching the file or a link to the file to the e-mail. If the user is interacting with a local e-mail client, the attachment agent runs on the user's computer. If the user is interacting with web-based e-mail, the attachment agent may run on either the user's computer (e.g., a JavaScript, Java, or similar application) or on the mobility server. The mobility server checks for an uploaded copy of a local file that the user selects. Users of the mobility service will have stored many of their documents in the cloud, on the mobility server, so the mobility server offers a link to the selected document instead of a duplicate copy of the document, which the attachment agent embeds in the e-mail. The recipient of the email will see an iconic or text link that invites the user to access the uploaded copy.

The icon provides a click-through link to the attachment. Optionally, view and files links would be embedded in the email body. The attachment link could duplicate features described in the incorporated applications for explicitly sharing an uploaded document by invitation. Automatically generating an invitation to view a shared document in the cloud could either be transparent to the user or, in a verbose mode, could allow options such as password protection for file access, date and quantity limits on downloads, encryption of the file, and expiration of the link.

The automatically generated attachment link will be compelling enough that people will see this as a better way to share files. Mobile users, in particular, will find it useful to avoid waiting for huge files to come down while travelling, unless they want them. Mobile users also will find it useful to avoid uploading huge files while traveling, because the previously uploaded version of the file will be available to attach to the email.

Here are implementation details of how this is done in practice.

1. An attachment agent intercepts the email request with a file attachment and accesses file properties. Existing metadata (file name, location and time/date stamp) and/or newly created metadata (hash key) reliably identify the file and version of the file. In one embodiment, a 20 byte hash key is generated by applying based on the MD4 hash algorithm. This is one of several algorithms that can be used to verify the content of a file. The resulting hash key is long enough to reliably distinguish between two similar files and to avoid collision between two very different files. In another embodiment, the full path and file name are used to uniquely identify a file and determine whether a copy has been sent to the cloud.

2. The attachment agent communicates with a server to see if this is the file has already been uploaded to the cloud and whether there are versions of the file to chose among.

a. For files that already are uploaded, a link is generated to attach to the email. In the style previously disclosed, this may include extending a share of the live file. The attachment agent optionally receives a one or more preview thumbnails and meta data and inserts the link, the thumbnails and meta data into the email.

In an alternative embodiment, the file being shared could be cached to a share area, which would segregate the email attachment from uploaded data, with the burden of duplication. By share area, we mean an area where static copies of files are kept for sharing. When a file is undergoing revision, the editor may desire to share the file in a particular state of revision. A copy the file would be made and posted to the share area. Subsequent edits to the original file would not affect the copy posted in the share area, although a later version also might be shared. This caching style might be preferred if the cloud storage did not maintain file versions; that is, if the cloud storage were updatable and might change between when the file was attached to the email and when the recipient viewed it. For updatable cloud storage, the email originator might be given the option of caching or not, thereby controlling whether the email recipient sees the latest version of the file or sees one that existed at the time of the email. A link to a live version of the file in the cloud could be provided, after matching the local file selected to a copy that already has been uploaded to the mobility server or uploaded. For updatable cloud storage, file access privileges, such as read only or updatable, could optionally be applied by the email originator.

In both styles of attachment, the matching of the local file selected for email attachment with a copy already uploaded is handled automatically, without requiring the user to initiate or guide the search.

b. For files that do not have an uploaded copy in the cloud, the file can be uploaded to the cloud by the upload agent in the background, independently of the email dispatch. Or, the attachment agent can duplicate some functions of the upload agent and handle the upload directly. In an automated mode, the agent would be configured to migrate to the cloud any file not in the cloud for which the user chose to send a link instead of sending the actual file. The agent, upon determining that the file had never been uploaded or upon determining that the local file version did not match any version of the file that previously had been uploaded, would queue the file for back up. In a verbose mode, the user would have control over whether to queue the file for back up, after being informed that the version of the file being sent had not been uploaded. Optionally, the user could be informed whether other versions of the file were already available in the cloud for attachment.

A file queued for back up would be pre-assigned a unique identifier, to which a link could be generated. The system would keep track of the status of the queued back up and generate an appropriate “please wait” message if the email recipient attempted to traverse the link before the queued operation was complete. Some options, such as including thumbnails of the attachment, might not be available before the queued upload or back up was completed. Alternatively, the email attachment agent could immediately cause thumbnails to be generated, once the attachment was queued for upload.

The automatic matching of local files to files stored in the cloud and attachment of links to the cloud version synergistically build on having an agent back up or upload files to the cloud, which increases usefulness of the files in the cloud, draws email originators into taking advantage of the cloud while travelling and to avoid duplication of files, and introduces email recipients to the cloud storage.

Automatic matching and attachments integrates the cloud storage into an everyday task without requiring the user to think about what's going on. It also gives the email originator more control over the attachment. The originator can control downloading, monitor access to the attachment (has the recipient read it vet?) and turn off access.

Recipients of the share enjoy all the advantages of the cloud storage sharing model. Mobile users enjoy optimized reading, that matches capabilities of their particular mobile device.

Duplication can be reduced because multiple copies of large file are not being copied everywhere, either as downloaded files or as attachments to email.

Mobile operators will not need to transmit as many attachments, at least on the upload side. This is especially useful on cellular networks, where the backhaul capacity from the cell towers to land lines may be limited.

The cloud storage supplier benefits from an increase in the number of passive logins by email recipients into the cloud storage, with opportunities created to recruit the email recipients into using the system.

### Corresponding Figures

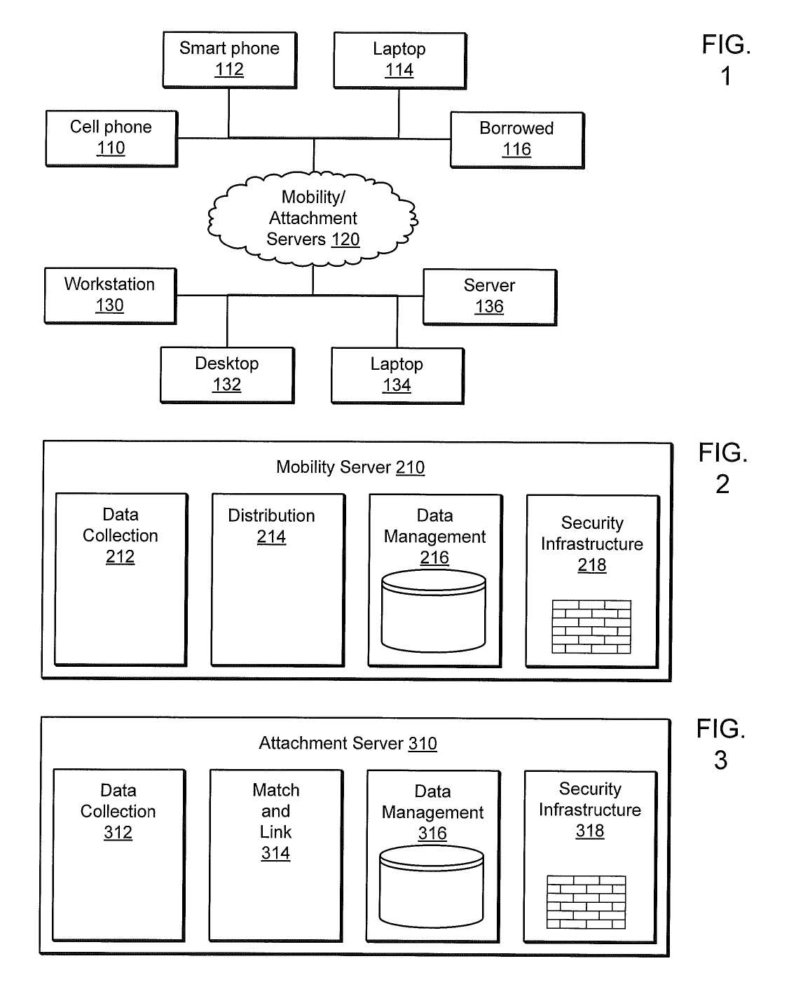

A private mobility network is depicted in FIG. 1. The network is homogeneous, having a variety of nodes attached that have differing display, network access and computing capabilities. This network includes three broad portions. Fixed components 130-136 have locations the generally did not change, such as workstations 130, desktop PCs 132 and servers 136. These nodes access the network through a local area network which may be wired or wireless. Mobile components of the network 110-116 are likely to be used while traveling. Cell phones 110, smart phones 112, and laptops 114 are examples of traveling devices. Smart phones include e-mail-enabled devices such as the Blackberry, iPhone, Treo, Windows Mobile devices and other personal digital assistants. These are examples of devices currently in use. Undoubtedly similar devices by other names will become popular in the future, without affecting this disclosure. “Borrowed” 116 refers to use of an internet kiosk PC or a community PC at an hotel, which is another common mobile access strategy.

Division of network devices into fixed and mobile needs to be somewhat flexible. For instance, a laptop or notebook computer may be used as a fixed device 134 with a docking station, external peripherals and/or a hardwired network connection. They may be used as true mobile devices 114, moving with the user as desired. To some extent, categorizing devices as fixed or mobile relates to their computing capabilities, which may, in turn, relate to their battery life. Fixed components often are better candidates for distributed processing of data, such as rendering data locally, than are mobile devices. Most network users are likely to use both fixed and mobile components. Much of the technology disclosed herein is particularly useful when a traveling user has less bandwidth or more limited computing capabilities than they would in their office.

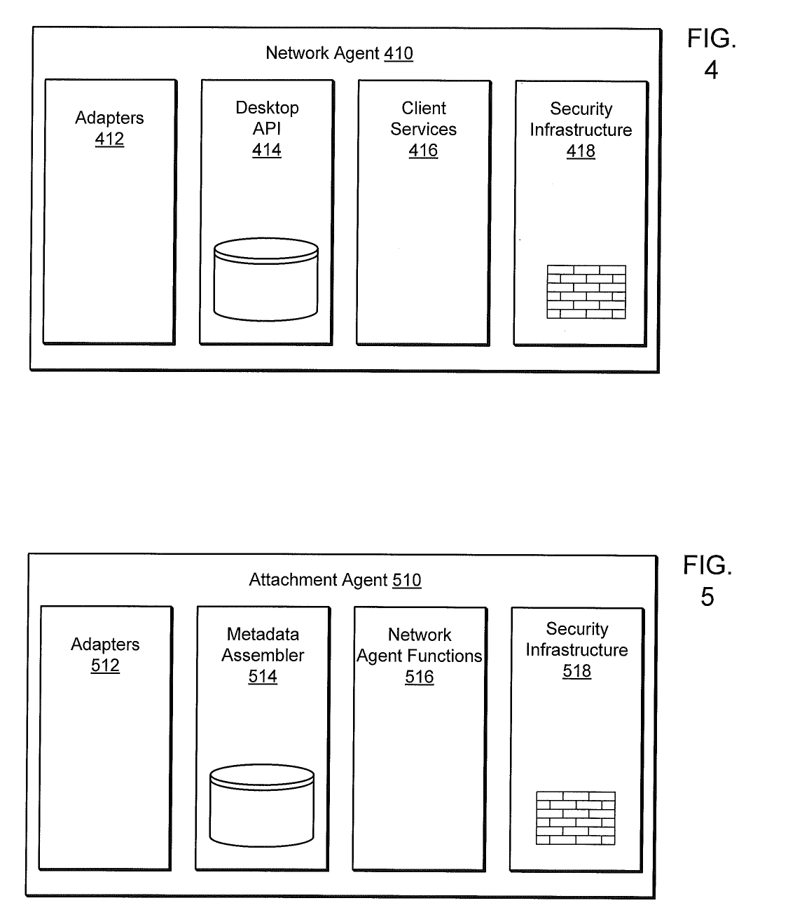

FIG. 2 is a block diagram of a mobility server. Components of the mobility server include a data collection module 212, a distribution module 214, data management module 216 and security infrastructure 218. Other modules disclosed in prior applications, such as the communication module, target device inventory module and a change management module have been omitted from FIG. 2 for the sake of clarity. The data collection module 212 relies on the communication module to manage communication between the mobility server and nodes 110-116 and 130-136. Adapters for communication services may support a variety of communication protocols, including HTML, XHTML, WAP, RSS, e-mail, instant messaging and SMS. As these communication protocols change, new adapters can be added to the communication module without varying from the spirit of this disclosure.

Although it is convenient and conventional to depict functional blocks in FIG. 2 as independent entities, these elements continually interact and may be merged into monolithic code segments (although doing so would typically be contrary to good programming practice.) For instance, outgoing communications to mobile devices through the communication module may require supplying specially formatted data that matches the screen configuration of particular mobile devices. HTML data may be rendered to a graphic format or some graphics in an HTML data stream may be omitted to match the memory, computing and graphic display capabilities of a target device.

The security infrastructure 218 provides security services. Typical components of the security infrastructure include encryption and decryption module, firewall, antivirus and anti-spam modules. In some embodiments, uploading of files, which potentially may be accessed by others, would be subject to antivirus and anti-spam controls, as is common for e-mail attachments.

The security infrastructure further includes a permissions module that maintains a registry of permission linkages. Permission linkages are more extensive and robust in the context of this disclosure than in a normal file system because unregistered users may be provided with access to uploaded files based on tokens rather than their identity. Alternatively, a new member module bailout for rapid simple addition of new members, some on a provisional basis, to limit access to uploaded files to registered members. For commercial reasons, registration of recipients who receive e-mail links is useful. It helps acquaint the recipients with system capabilities and increases the likelihood that they will become customers.

The target device inventory tracks the device's possessed by registered members, including device rendering capabilities. This information can be shared explicitly by the user or extracted from data streams as user devices interact with the mobility server. In some embodiments, the user profile may track which native formatted files, such as Microsoft Excel files, can be handled by the device. Then, the rendering engine would have the alternative of downloading native files instead of rendering them.

The data collection module 212 oversees collection of data from network members into the data management system 216. Incoming data is not simply dumped into memory. As described in the prior application, the data collection module may determine alternative pre-rendered formats in which the data should be stored.

The distribution module 216 handles distribution of data from the mobility server to network members. A rendering module may perform a rendering function, translating data from one format to another, or selecting pre-rendered versions of files for distribution. A streaming module provides the capability to stream data directly from the mobility server to the user. This is useful for media files such as video or sound, which a user may want to experience, but not store locally on a mobile device.

The data management model 216 manages the storage process. Details of the data management have previously been explained. Typical components of data management may include a primary data store with the central index, a member profile store, a metadata store and a version manager. The primary data is stored and its associated index would typically be implemented by a large-scale database system that is capable of storing data in a variety of formats with indexing, search and retrieval capabilities. Vendors such as Oracle, Microsoft, MySQL and Sybase provide large-scale databases. As database technology develops, more capable database systems may be used, consistent with this disclosure. The existence of a data management module 216 does not exclude the possibility that other modules, such the security infrastructure module 218 will maintain their own ancillary databases, such as permissions data.

A member profile store may be dedicated to handling member-related information. A separate store for this kind of information allows rapid and secure access to data. It is well suited to the mix of mobile and fixed devices. A member profile store may include member-specific data items, such as fixed personal data (name, address, etc.), device information for the member (equipment ID, memory capacity, screen capacity, rendering capacity, etc.; and activity information (alert triggers and history, tracking history).

A metadata store element of data management 216 is used in responding to parameters identifying a selected e-mail attachment. Metadata includes a variety of information about the data itself, such as filenames, file locations within a directory structure, permissions, sharing information, monitoring our alert information, change information and hash codes. Metadata allows the mobility server to match an uploaded file to parameters that describe a local file selected to be used as an e-mail attachment. In one embodiment, file names, date and time stamps and file locations within a directory structure support identification of a matching file. In another embodiment, filenames and hash codes support matching. In matching file may, in turn, be linked to versions of the file.

A version manager component of the data management 216 oversees storage and tracking of document versions. Versioning may be configurable to select number of versions of a document to be saved and the intervals at which versions should be collected. For instance, hourly intervals might apply to versions over a week, daily versions over a month and weekly versions beyond that. Or, the user could explicitly declare versions. Storage in the cloud could be integrated with a document management system that provides versioning control.

A change management component of data management 216 monitors access to, changes in and forwarding of documents that have been uploaded. For example, when an uploaded document is delivered to a recipient, who opens and edits the document, then forwards the document, the change management component tracks the recipients interaction with the mobility server. Tracking results are stored in a profile store. And alerting module may notify subscribers the occurrence of specific events, such as the recipient downloading the document or forwarding it.

The mobility server 210 typically is installed and operated in a large-scale data center, but it could be privately maintained by an individual organization. In one embodiment, physical mobility servers would be grouped into server cells for storage administration. The details of data center administration are tangential to the technology disclosed.

FIG. 3 is a functional block diagram of an attachment server 310. Many components of the attachment server parallel components of the mobility server 210. There is significant overlap between the two servers in data collection 312, data management 316 and security infrastructure 318. The two servers could be hosted on the same hardware or integrated into a single application, if desired.

The match and link module 314 of the attachment server supports processing of attachment parameters received from an attachment agent. The match component receives metadata that identifies the file which a user intends to attached to an e-mail. The file name is one example of metadata. Other examples include date and timestamp, location within a file directory structure, file size and the hash code. Alternatively, Rabin/Broder fingerprinting or so-called shingles, typically employed by search engines to identify duplicate and near duplicate files, could be used to supply metadata. One or more of these metadata are used by the module 314 to locate a matching or similar uploaded file. Metadata describing the file located may be returned to a user for a decision on whether to attach the link in place of the local file. User decision-making can be solicited in all cases, in multiple version cases or in close but not exactly matching file cases. Or, the process can be fully automated to save the user any trouble, with attachments used and links omitted in risk prone cases.

A shared copy area, mentioned above for an alternative embodiment, could be managed by the data management component 316. To freeze a live file and share the frozen version, a copy would be made of the file and a link made available to the copy, rather than the live file.

The link generating component generates one or more links to versions of the document selected by the match component. As described in the prior application, a link that accesses a file stored in the cloud may be supplemented by thumbnails, a forwarding link, an editing link and links for a typical document operations. The link generating component may be operative as soon as the matching document is located or it may wait for a user decision on whether to use the link. Multiple links can be generated to reduce the back-and-forth between the mobility server and an attachment agent.

The data management module 316 of the attachment server 310 captures and tracks one or more e-mail addresses associated with the e-mail and e-mail attachment. The e-mail addresses can be matched to registered members or tracked for enlistment of new and provisional members.

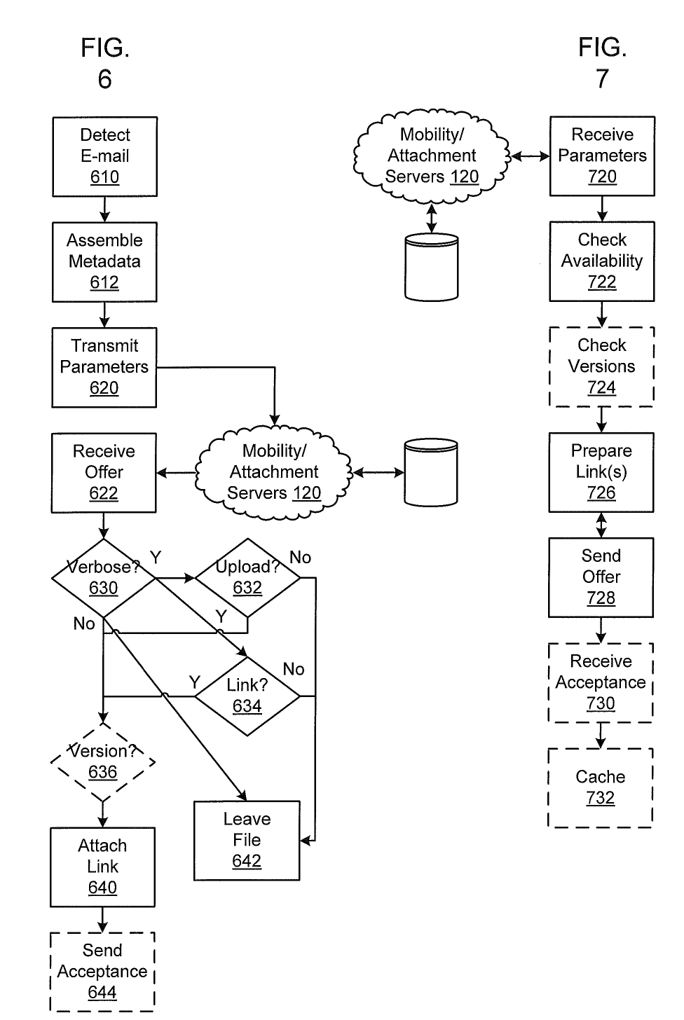

FIG. 4 is a functional block diagram of a network agent 410 that resides on network components capable of mounting such software. Not all mobile devices will be capable of mounting a network agent. The agent acts as a network client and interfaces with the mobility server through security infrastructure 418. Some components of the security infrastructure may be duplicated on the network agent and mobility server. Others may run only once, such as virus checking or spam checking, with a bias towards distributed processing to take advantage of spare resources on fixed devices.

The desktop API 414 integrates agent functionality with operations of the host computer. APIs are furnished as required to provide compatibility with various PC architectures and desktop applications. One API, for example, would allow the agent to operate in a Microsoft Windows environment, while others would provide for operation in Apple Macintosh and Linux environments.

Desktop adapters 412 provide working interfaces between the agent and applications running on the local host, such as word processing and e-mail. These modules are written under the API to allow tight integration to key desktop functionality, such as a file system adapter, a Microsoft Outlook® adapter, a search engine adapter, a customer relation management (CRM) system adapter, document management system adapter and other adapters. The system is designed for easy development of new or improved adapters as required by technological developments. It should be noted that some of the desktop adapters integrate with applications that operate in a client-server or web-based configuration, such as CRM applications.

A client services module 416 provides both operational and administrative services for the system. Operationally, this module oversees the local portion of automatic uploading. The uploading may be for backup or mobility purposes. Administratively, this module provides a number of services that enhance efficient operation of the system. Workload balancing is one such service. Allocation of tasks between servers and nodes is another service. Timing of data communications, such as uploading and downloading, which requires significant bandwidth, can be spread to off-peak times to smooth resource demands. The network agent and complementary components of the mobility server cooperate to balance workload between the local host and the server, distributing tasks to the nodes when they are able to handle them under existing workload and traffic conditions.

Other modules of the network agent, described in the prior application, such as the rendering module, have been omitted from FIG. 4 for the sake of clarity.

While the description above describes an embodiment that practices the technology disclosed, it should be clear that the technology can be implemented in a wide variety of specific forms. For example, the mobility server functionality could be implemented as a conventional server/data center or it could be structured in a more distributed fashion. The server itself could be structured conventionally or it can be fashioned under any of the emerging architectures, such as Web services, enterprise service architecture or others. A software-based system embodiment has been described, but the same results can be achieved with a hardware implementation or a hybrid firmware structure. The network agent, in particular, is apt to undergo considerable evolution, given the technology for mobile devices is quickly evolving to provide greater functionality in smaller packages. Initiatives such as Apple's iPhone and Google's open architecture for cellular phones will accelerate the rate of innovation among mobile devices.

FIG. 5 depicts an attachment agent 510 that also runs on the local host of devices that send e-mail. When the attachment agent is implemented for web-based e-mail, it may be implemented as a browser add-in, toolbar, a Java applet, a JavaScript application, flash application or other browser technology. A browser add-in or toolbar might be programmed in C++, C or Java.

The adapter module 512 and security infrastructure 518 are similar in the attachment agent to the network agent. Adapters in the attachment agent will be directed to e-mail clients or e-mail operations through browsers. The adapter module detects an e-mail attachment. This detection may take place as the attachment is added to the e-mail or when the user hits the “send” button.

The metadata assembler 514 responds to detection of the attachment by collecting metadata regarding one or more attachments to be forwarded through the security infrastructure 518 to the mobility server 210. Data may be collected from the e-mail client, from a file directory, from a document management system or a similar source of metadata. Metadata also can be created, such as applying a hashing or fingerprinting algorithm to the file to be attached. The metadata is prepared in a manner that enhances the ability of the attachment server to find a matching or similar file previously uploaded to the mobility server.

In this context, one will understand that the mobility and attachment servers can be organized as one or more distinct servers that collectively handle uploading of files and generation of attachment links. Operationally, it is anticipated that the attachment server will be a distinct function, which may be deleted to separate hardware posted on the same hardware as the mobility server. However, the mobility and attachment functions could be integrated into a single application, consistent with this disclosure.

The network agent functions module 516 either delegates operations the network agent 410 or carries them out. Any instance where the attachment server reports that no matching files are found, the user can be given the option of killing the file to be uploaded to the mobility server. Queuing to file for upload and generating a link that will be valid once the file has been uploaded are functions that we previously have described as being assigned to the network agent 410. These functions can be carried out by shared code, can be delegated from the attachment agent 510 to the network agent 410 or replicated in the network agent functions module 516.

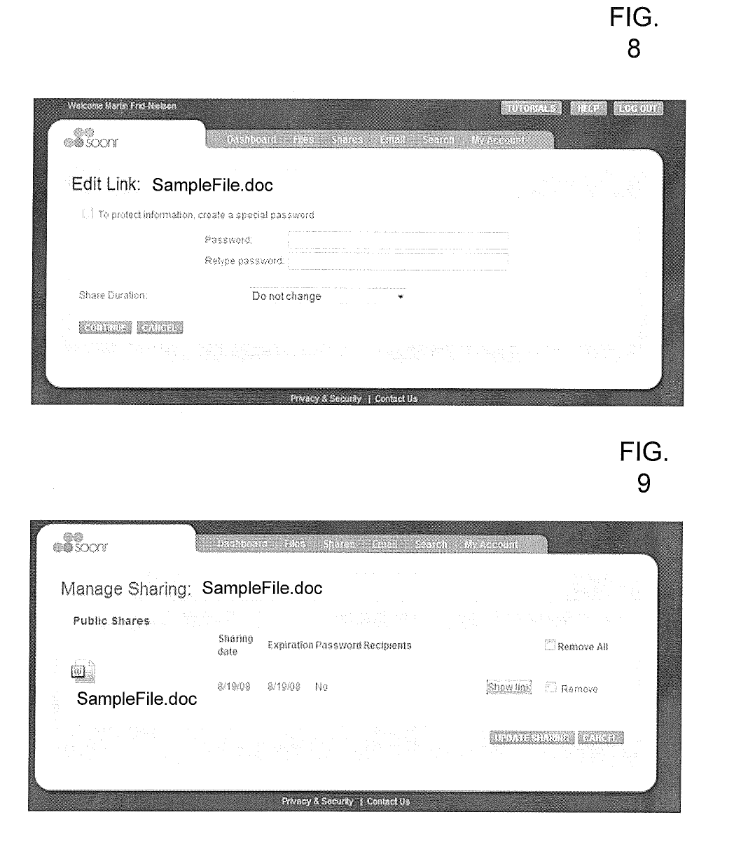

FIGS. 6 and 7 are high level flowcharts for handling an attachment event, from the perspectives of the attachment agent and attachment server. FIG. 6 begins with detection of an e-mail attachment 610. As described above, this detection may take place as the attachment is added to the e-mail or when the user pushes the “send” button. This and following steps of the process can proceed in the background, as soon as an attachment has been selected, with a reduction in latency, or can await the users confirmation of the final content of the e-mail, with a reduction in processing. Detection of an e-mail attachment is followed by assembly of metadata 612. As described above, this metadata can be collected from the e-mail client, a file directory, document management system or a similar source. The metadata also can be created, such as by applying a hashing or fingerprinting algorithm to an attachment. The attachment agent transmits the parameters 620 the attachment server 620 and awaits a response. The attachment agent receives a response 622. The response may indicate a match or a match failure. In the case of a match or near match, the response 622 includes an offer of a particular file to attach. In the case of an exact match and a user choice to automate as much as possible, the response 622 may include a link or data from which the attachment agent constructs a link. It may include thumbnails and file operations, as described above. In a more verbose mode, where the user has chosen to be prompted for inclusion of links instead of files, the response 622 includes metadata that describes the file offered. In some embodiments, the metadata may describe the closeness of a near match and may describe two or more alternative versions of a file from which the user can select. The versions may be related as successive versions of the same file in the same file structure, or may be related logically, such as Word and PDF versions of the same file.

The number of choices given to the user following the response 622 depends on a user choices to how verbose the dialogue should be 630 and the result of the attachment server matching process. In a verbose mode, a match (optionally, with versions 636) or a near match would lead to a dialogue 634 and ask the user whether to substitute a link for an actual file. This dialog may include selecting among versions or verifying the nearly matching file is appropriate to attach. If the user responds to the upload dialogue 632 by choosing to attach a file link instead of the file, the link is attached 640. The attachment agent may use data received before the dialogue 622 or may further interact with the attachment server 120 to obtain link data. In the verbose mode, an indication from the attachment server that no match was found could, optionally, lead to a dialogue that offers to upload the file 632. Embodiments of a dialogue that selects files for uploading them and described in the previous application. Adapted to e-mail attachments, the attachment agent would both queue the attachment for upload and interact with the mobility and/or attachment server 120 so that a unique identifier could be embedded in the link which would be valid once the upload was completed. Attachment of a link could, in some implementations, be confirmed in a message 644 from the attachment agent to the attachment server. In some embodiments, the acceptance message could lead the attachment server to forward link information to the attachment agent. The attachment agent could assign a relatively high priority to uploading the e-mail attachment, at least among network agent functions. In response to either a link dialogue 634 or an upload dialogue 632, the user could choose to leave the file as an e-mail attachment 642, instead of substituting a link 640.

The attachment agent is responsible for interacting with the e-mail client to accomplish substitution of one or more links in place of the local file originally selected by the user for attachment in e-mail.

FIG. 7 depicts the substitution of a link for a file from this perspective of the attachment server 120. Parameters transmitted 620 by the attachment agent are received 720. The attachment server uses metadata received to check for the availability 722 of a matching or near matching file and, optionally, to check for versions of the file 724. The sequence and extent to which the attachment server sends metadata and links depends on the combination of user configuration parameters and results of checking availability 722. In a non-verbose mode with an exact match and no versions, links may be prepared 726 and sent without a separate offer for attachment. In a verbose mode, links 726 may accompany an offer 728 or may be sent after receiving an acceptance of an offer 730.

In some embodiments, the attachment server may copy a file from the cloud to a link cache 732. For instance, if file versions are not maintained and files in the cloud are subject to active editing, a user may choose to freeze the file version used as an attachment. Then, the attachment server would create a cached copy 732 of the attachment.

The flows and tasks described vary somewhat when a web-based e-mail client is used, instead of an e-mail client on the local machine. The description above primarily corresponds to use of a local client, such as office Outlook or Mozilla's Thunderbird™ Microsoft's Office Outlook also is available using a web-based interface in a browser, so we describe here how the attachment agent functions for web-based e-mail. For local file attachments, the attachment agent metadata assembler runs on the local machine, interacting with the browser. In a typical dialogue, the user browses for a local file to attach. The attachment agent may begin its work either as soon as a local file is been selected for upload or when the user confirms that the file should be uploaded. This typically involves two distinct user actions. The attachment agent assembles metadata and interacts with the attachment server to offer the same functionality as described above in the context of an e-mail client running on a local machine. Depending on the degree of integration with Web interface, the attachment agent may either directly insert a link in the e-mail message and delete the attachment specification from the data stream or it may present a pop-up window with link information and instructions for the user to manually insert the link and delete the attachment.

FIGS. 8 and 9 are exemplary user interfaces for explicitly managing sharing of files. FIG. 8 depicts a screen for optionally adding a password that an e-mail recipient would need to enter to access the shared attachment. FIG. 9 depicts a screen used to manage a share after creation. In both figures, the attached file is “SampleFile.doc.”

### Some Particular Embodiments

The technology disclosed technology disclosed may be practiced as a method or device adapted to practice the method. The same method can be viewed from the perspective of the client that forwards attachment metadata to the server or the server that uses the metadata to find one or more matching or nearly matching uploaded files. The technology disclosed may be an article of manufacture such as media impressed with computer program instructions to carry out computer-assisted substitution of links to uploaded files for attachment of selected files in outgoing e-mail.

The technology disclosed may be practiced as a method of making an enhanced client device that forwards attachment metadata or a method of making a server that uses the metadata. The method includes downloading computer program instructions to an existing computer and running an installer to combine the computer program instructions with the computer on which they will run. The instructions are functional in the combination, because they control the operation of the computer.

One embodiment is a method of associating a file with an e-mail without uploading the file at the time that the e-mail is composed. This method includes installing and using an automated upload agent on a first computer. The automated upload agent is adapted to selectively copy data from the first computer to a remote mobility server. Typically, a user specifies parameters for selectively copying the data. However, a system administrator might supply those parameters for users. The method continues with initiating an e-mail from a second computer, including specifying a file to be used as an attachment in e-mail. The second computer may be the same computer as the first computer. Or, the user may have a desktop computer or workstation which is the first computer and a laptop or other mobile device which is the second computer.

The file specified to be used as an attachment may be local to the second computer. A file local to the second computer is one that appears in a directory structure that is mounted on the second computer's file system and not mounted on the computer file system of the e-mail recipient. Alternatively, in a narrower definition of a local file, it would not include files in WebDAV (web-based distributed authoring and versioning) or equivalent directories mounted on the second computer's file system. Practically, this narrower definition limits local files to files mounted on the second computer's file system that are accessible via a highband width data connection. By “high” bandwidth, given present technology, we mean to distinguish between a wired or wireless local area network, one hand, and the cellular network, on the other hand. The high-bandwidth network has access speeds of at least 10 megabits per second, utilizing IEEE 802.11a or better technology. Yet a narrower definition of a local file would be a file in a directory structure mounted on the second computer that is physically stored on media that typically is accessed from the second computer with a round-trip latency of less than 10 or 5 milliseconds. The narrowest definition of a local file is a file physically stored on persistent media in or directly connected to the second computer. This includes hard drives and optical media on a laptop computer, solid-state drives a laptop computer, USB and FireWire connected drives. The more local the file, the more significant the potential time and latency savings from using file copy already uploaded to the cloud. However, even when files mounted in WebDAV directories are included in the definition of local files, the technology disclosed reduces duplication and enhances access for an e-mail recipient who does not have the same file mounted on the recipient's computer.

The method further includes receiving electronically an offer to supply as the attachment an uploaded copy of the file to be attached. The uploaded copy is a copy that was transmitted from the automated upload agent on the first computer to the remote mobility server before the user initiated the e-mail from the second computer. The method continues with electronically accepting the offer of the uploaded copy of the file to be attached and causing the e-mail to be sent with a link to the uploaded copy.

One application of this method involves e-mail initiated using a browser-based interface to a remote e-mail server. For instance, using a web-based interface to Outlook. This application of the method includes receiving an offer to supply the uploaded copy as the attachment from the remote e-mail server. This application further may involve instructing the remote e-mail server either to use a link to the uploaded copy of the file or to incorporate the uploaded copy of the file into the e-mail.

Another application of this method involves e-mail initiated using a local e-mail client, such as Outlook or Thunderbird. In this application, the method further includes running an attachment agent on the second computer operatively coupled to the local e-mail client. The attachment agent communicates with a remote attachment server. The offer to supply the uploaded copy as the attachment is received electronically from the remote attachment server. In this application, the remote attachment server may be clustered with, hosted on the same machine as or integrated with the mobility server.

In either application, the specification of the file to be attached may include metadata that distinguishes among files with the same name. The metadata may include a file path specification that distinguishes the file from other files with the same content. It may include a file and date stamp. It may include a hash code calculated from the file, or some combination of metadata fields.

In either application, the offer further may include multiple versions the file to be attached and the method includes selecting one or more of the multiple versions.

The technology disclosed also can be described as a method from the perspective of an attachment or mobility server. It is again a method of associating a file with an e-mail without uploading the file at the time that the e-mail is composed. This method includes receiving at a remote mobility server from an automated upload agent running on a first computer data to be copied to the remote mobility server. The method includes receiving from a second computer a request to initiate an e-mail, including specification of a file to be used as an attachment to the e-mail. The method includes finding among files on the remote mobility server at least one uploaded copy the file to be used as an attachment. The uploaded copy may be identical or nearly identical to the specified file. The method includes offering for the second computer use the uploaded copy the file as the attachment, or by the second computer can cause the uploaded copy to be used without the second computer uploading the file after initiating e-mail.

This method, from the perspective of the attachment or mobility server, is compatible with either a local e-mail client or a web-based e-mail interface. When the e-mail is initiated using a local e-mail client, the method may farther include receiving the specification of the file to be used as the attachment from an attachment agent running on a second computer. The offer to supply the uploaded copy as the attachment is electronically transmitted from the remote attachment server to the attachment agent. With the Web-based e-mail interface, the offer to supply the uploaded copy of the attachment may appear in a pop-up window triggered by the attachment server.

While the technology disclosed is disclosed by reference to the disclosure and examples detailed above, it is understood that these examples are intended in an illustrative rather than in a limiting sense. Computer-assisted processing is implicated in the described embodiments. Accordingly, the technology disclosed may be embodied in methods for substitution of links to uploaded files for attachment of selected files in outgoing e-mail; systems including computer program instructions and computer resources to carry out substitution of links to uploaded files for attachment of selected files in outgoing e-mail; systems that take advantage of computer-assisted substitution of links to uploaded files for attachment of selected files in outgoing e-mail; media impressed with computer program instructions to carry out substitution of links to uploaded files for attachment of selected files in outgoing e-mail; data streams impressed with computer program instructions to carry out substitution of links to uploaded files for attachment of selected files in outgoing e-mail; or computer-accessible services that carry out computer-assisted substitution of links to uploaded files for attachment of selected files in outgoing e-mail. It is contemplated that modifications and combinations will readily occur to those skilled in the art, which modifications and combinations will be within the spirit of the technology disclosed and the scope of the following claims.

We claim as follows:

1. A method of associating a file with an e-mail without uploading the file at the time that the e-mail is composed, the method including:
installing and using an automated upload agent on a first computer, wherein the automated upload agent is adapted to selectively copy data from the first computer to a remote mobility server;
initiating an e-mail from a second computer, including specifying a file to be used as an attachment to the e-mail;
receiving electronically an offer to supply as the attachment an uploaded copy of the file to be attached, wherein the uploaded copy was transmitted from the automated upload agent on the first computer to the remote mobility server before the initiating of the e-mail from the second computer; and
accepting the offer of the uploaded copy of the file to be attached and electronically causing the e-mail to be sent with a link to the uploaded copy.

2. The method of claim 1, wherein the e-mail is initiated using a browser-based interface to a remote e-mail server and the offer to supply the uploaded copy as the attachment is received from the remote e-mail server.

3. The method of claim 2, wherein acceptance of the offer instructs the remote e-mail server to incorporate the uploaded copy in the e-mail.

4. The method of claim 2, wherein acceptance of the offer instructs the remote e-mail server to incorporate in the e-mail a link usable to retrieve the uploaded copy.

5. The method of claim 1, wherein the e-mail is initiated using a local e-mail client, further including:
running an attachment agent on the second computer coupled to the local e-mail client and the attachment agent communicating with a remote attachment server;
wherein the offer to supply the uploaded copy as the attachment is received electronically from the remote attachment server.

6. The method of claim 1, wherein the first computer is the second computer.

7. The method of claim 1, wherein the second computer is a palm held personal communications device.

8. The method of claim 1, wherein the specification of the file to be attached includes a file path specification that distinguishes the file from other files with the same content that are located elsewhere.

9. The method of claim 1, wherein the specification of the file to be attached includes a file name and a hash code calculated from the file.

10. The method of claim 1, wherein the specification of the file to be attached includes a file name and meta data.

11. The method of claim 1, wherein the specified file is local to the second computer.

12. The method of claim 11, wherein the file local to the second computer physically resides on a drive on the second computer.

13. The method of claim 11, wherein the file local to the second computer physically resides on a drive on an other computer and appears in a directory structure that is logically mounted on the second computer.

14. The method of claim 13, wherein the first and the other computer is connected by a local or storage area network with an access latency of less than 5 milliseconds.

15. The method of claim 1, wherein the offer further includes multiple versions of the file to be attached and the method further includes selecting one or more of the multiple versions.

16. A method of associating a file with an e-mail without uploading the file at the time that the e-mail is composed, the method including:
receiving at a remote mobility server from an automated upload agent running on a first computer data to be copied to the remote mobility server;
receiving from a second computer a request to initiate an e-mail, including specification of a file local to be used as an attachment to the e-mail;
finding among files on the remote mobility server at least one uploaded copy of the file to be used as an attachment; and
offering for the second computer to use the uploaded copy of the file as the attachment, whereby the second computer can cause the uploaded copy to be used without the second computer uploading the file after the initiating of the e-mail.

17. The method of claim 16, wherein the e-mail is initiated using a local e-mail client, further including:
receiving the specification of the file to be used as the attachment from an attachment agent running on the second computer;
wherein the offer to supply the uploaded copy as the attachment is electronically transmitted from the remote attachment server to the attachment agent.

18. The method of claim 17, wherein the offer further includes multiple versions of the file to be attached and the method further includes selecting one or more of the multiple versions.
